(19) United States
(12) Patent Application Publication
(10) Pub. No.: US 2004/0192249 A1
(43) Pub. Date: Sep. 30, 2004

(54) Radio set

(76) Inventor: Vincent K. Lee, Taipei (TW)

Correspondence Address: David E. Dougherty, Dennison, Schultz & Dougherty, 612 Crystal Square 4, 1745 Jefferson Davis Highway, Arlington, VA, 22202, US

(21) Appl. No.: 10/125,606

(22) Filed: Apr. 19, 2002

(51) Int. Cl. H04B 7/00

(52) U.S. Cl. 455/347; 455/66.1

(57) ABSTRACT

A small-size radio set includes a lower case to which an upper case and a liquid ornament are connected. The liquid ornament is so shaped and dimensioned that it together with the upper case form a complete upper part of the radio set to cover a top of the entire lower case and provide an integral appearance for the radio set. The lower and the upper cases are configured to shapes of various fashionable goods. The radio set having the uniquely shaped cases and the liquid ornament incorporated with the upper case not only provides the functions of a radio, but also shows new life and unique attraction.

### BACKGROUND OF THE INVENTION

The present invention relates to a radio set, and more particularly to a small-size radio set having a liquid ornament incorporated therewith.

People's living quality is increasingly upgraded with the rapid developments in different industrial fields. Most consumers demand for higher quality and better functions in selection of their desired products. The selected products must be economical and cost effective while they provide good basic functions. The selected products must also be novel and unique in their appearances. In other words, for consumers, an ideal product must be able to provide the function intended for it, have small volume, be cost effective, and have novel and unique appearance to increase the added value of the product. To satisfy the consumers, it is necessary to include other special structure and effect to create the novelty and uniqueness in designing a product, particularly a product that is intended to be a present or a giveaway.

### SUMMARY OF THE INVENTION

A primary object of the present invention is to provide a small-size radio set that not only provides the basic functions of a radio set, but also shows completely novel and fashionable appearance to create unique attraction and highly added value for suitably using as a present or a giveaway.

To achieve the above and other objects, the radio set of the present invention mainly includes a lower case to which an upper case and a liquid ornament are connected, and a circuit board assembly mounted between the lower and the upper case to provide basic functions of a radio set. The liquid ornament is so shaped and dimensioned that it together with the upper case form a complete upper part of the radio set to cover a top of the entire lower case and provide an integral appearance of the radio set. The lower and the upper cases are configured to shapes of various fashionable goods. The radio set having the uniquely shaped cases and the liquid ornament incorporated with the upper case not only provides the functions of a radio, but also shows new life and unique attraction.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is an exploded perspective view of a radio set according to an embodiment of the present invention;

FIG. 2 is an assembled perspective view of FIG. 1;

FIG. 3 is a partially sectioned side view of the radio set of FIG. 1;

FIG. 4 is a perspective view of a radio set according to another embodiment of the present invention; and

FIG. 5 is a perspective view of a radio set according to a further embodiment of the present invention.

### DETAILED DESCRIPTION OF THE PREFERRED EMBODIMENTS

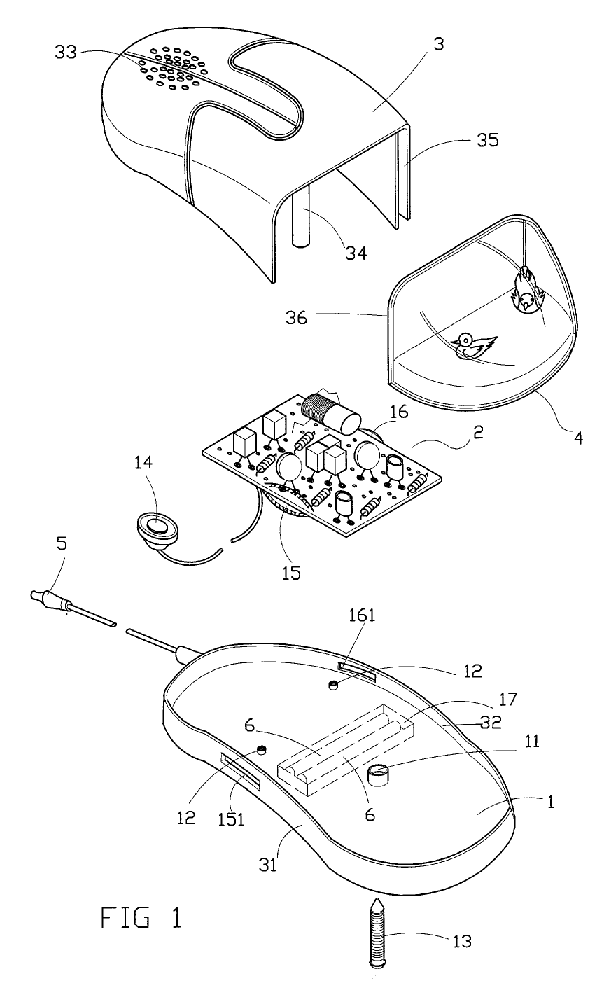

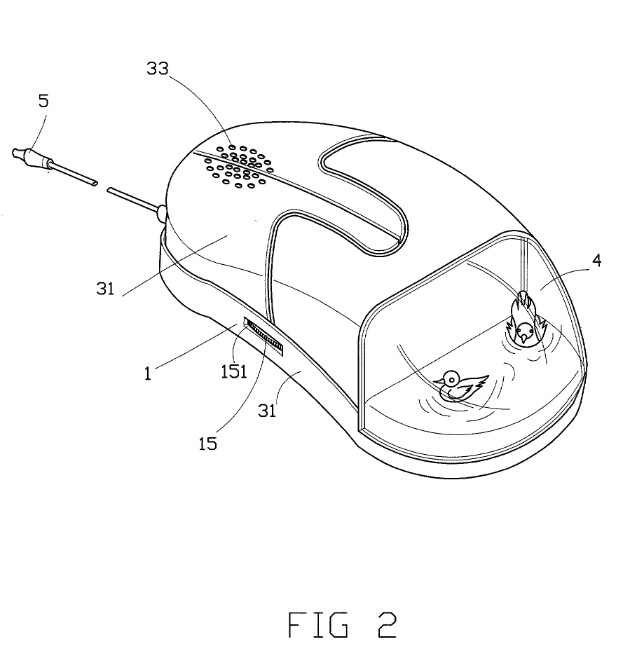

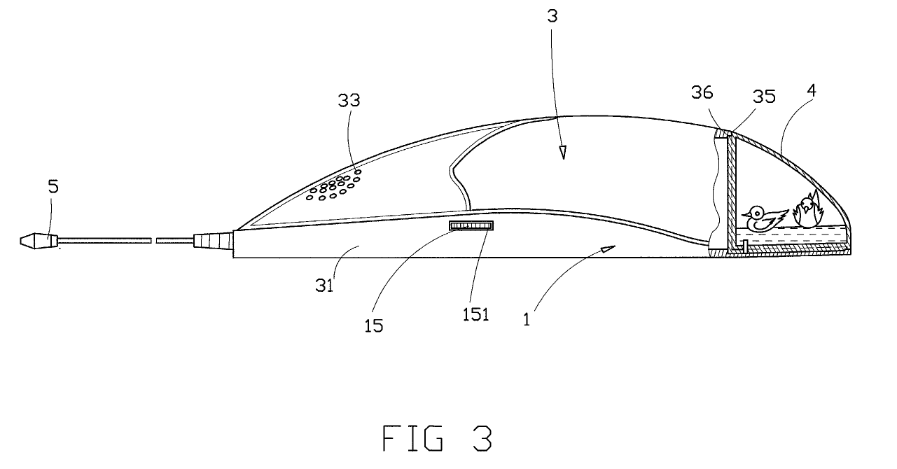

The present invention provides a small-size radio set that is configured to show shapes of various fashionable goods, such as a cigarette case, a mouse, a mini car, etc. Please refer to FIGS. 1 to 3 in which a radio set according to a first embodiment of the present invention is shown. In this embodiment, the radio set is shown as a mouse and includes a lower case 1, a circuit board assembly 2, an upper case 3, and a liquid ornament 4. A plug body 5 for connecting to an earphone is provided at a front end of the lower case 1, so that the plug body 5 looks like a power cord for a mouse to meet the configuration of a mouse.

The lower case 1 is provided at an underside with a compartment 17 for batteries 6. Conductive plates are provided in the battery compartment 17 for electrically contacting with the circuit board assembly 2 after the latter is mounted in the lower case 1. Internally threaded seats 11, 12 are provided on an inner bottom surface of the lower case 1 for screws 13 to extend therethrough into the radio set.

The circuit board assembly 2 includes a loudspeaker 14, an on-off switch & volume control 15, and a channel selector 16. The circuit board assembly 2 is mounted in the lower case 1 with the on-off switch & volume control 15 and the channel selector 16 located in two openings 151, 161, respectively, correspondingly formed at two lateral walls 31, 32 of the lower case 1.

The upper case 3 is provided near a top front portion with a perforated area 33 corresponding to the loudspeaker 14 of the circuit board assembly 2 mounted in the lower case 1 below the upper case 3, so that sounds produced by the loudspeaker 14 could be sent out via the perforated area 33. The upper case 3 is also provided at an inner top surface with a downward extended and internally threaded hollow bar 34 corresponding to the internally threaded seat 11 provided on the lower case 1. By upward threading the screw 13 through the threaded seat 11 into the internally threaded bar 34, the upper case 3 is connected to a top of the lower case 1 to cover front and middle areas of the lower case 1.

The liquid ornament 4 is designed for connecting to a rear top of the lower case 1 and a rear end of the upper case 3. The liquid ornament 4 is so shaped and dimensioned that it and the upper cover 3 together form a complete upper part of the mouse-shaped radio set. More particularly, when the upper case 3 is molded, a part thereof corresponding to a rear portion or a middle portion of the lower case 1 is cut off, and the cut-off part of the upper case 3 is made up with the liquid ornament 4. The liquid ornament 4 may be connected to the lower and upper cases 1, 3 in any acceptable manner without particular limitation. In the embodiment illustrated in FIGS. 1 to 3, the upper case 3 is provided along an inner peripheral edge of the cut-off rear end with a groove 35, and the liquid ornament 4 is provided along a peripheral edge of an end surface adjacent to the cut-off rear end of the upper case 3 with a tongue 36, so that the liquid ornament 4 is connected to the cut-off rear end of the upper case 3 through engagement of the tongue 36 with the groove 35.

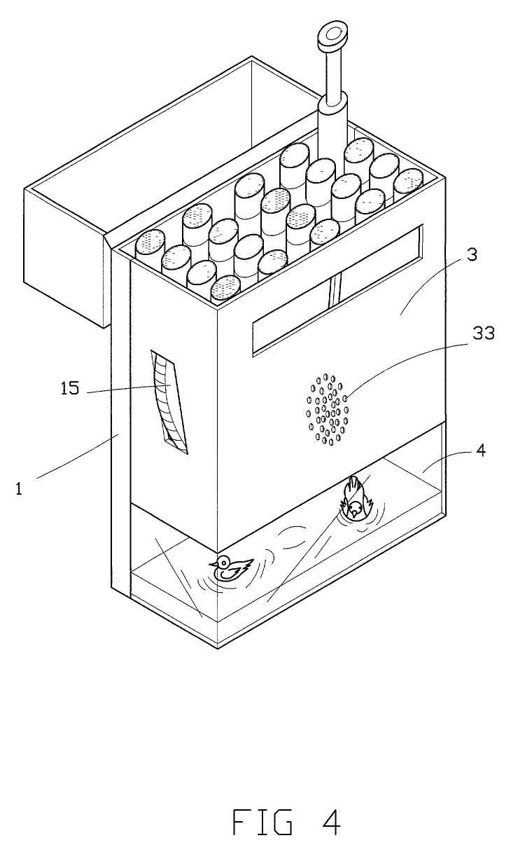

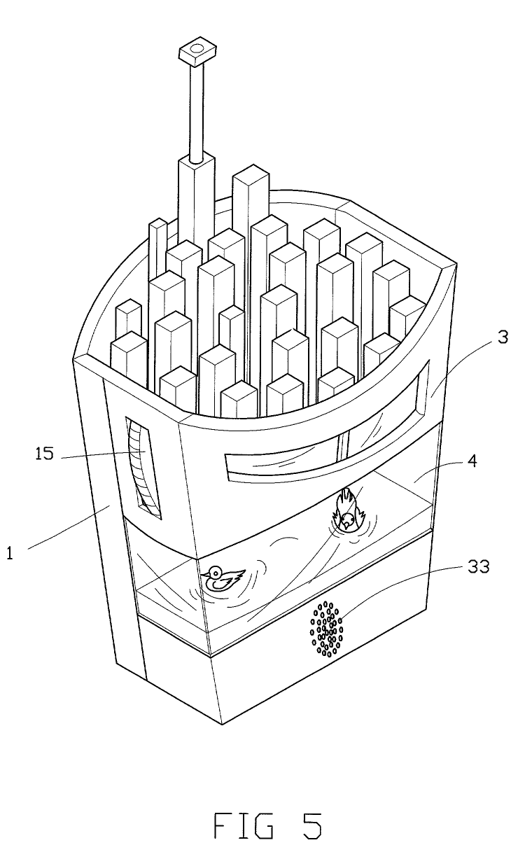

FIG. 4 shows a cigarette-case shaped radio set according to a second embodiment of the present invention, and FIG. 5 shows a French-fries-pack shaped radio set according to a third embodiment of the present invention. As can be seen in FIGS. 4 and 5, the liquid ornaments 4 for the second and the third embodiments are connected to the upper cases 3 to correspond to a rear and a middle portion, respectively, of the lower cases 1. The liquid ornament 4 forms an integral part of the radio set without detriment to an overall appearance of the radio set.

What is claimed is:

1. A radio set comprising a lower case, a circuit board assembly mounted in said lower case, an upper case connected to a top of said lower case to cover a part of said lower case, and a liquid ornament connected to said upper case to fitly cover another part of said lower case that is not covered by said upper case; and said liquid ornament being so shaped and dimensioned that it together with said upper case form a complete upper part of said radio set corresponding to a configuration of said lower case.

2. The radio set as claimed in claim 1, wherein said lower and said upper cases are configured to shapes of various fashionable goods.
